(19) United States
(12) Patent Application Publication
(10) Pub. No.: US 2002/0098339 A1
(43) Pub. Date: Jul. 25, 2002

(54) Polyolefin resin foamed sheet and production method thereof

(75) Inventors: Satoshi Hanada, Ibaraki-shi (JP); Ryuma Kuroda, Ibaraki-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 09/994,641

(22) Filed: Nov. 28, 2001

(30) Foreign Application Priority Data
Nov. 30, 2000 (JP) 2000-364497
Nov. 30, 2000 (JP) 2000-364498

(51) Int. Cl. B32B 3/26; B32B 9/00

(52) U.S. Cl. 428/318.4; 428/304.4

(57) ABSTRACT

A sheet excellent in surface smoothness in which bubble break in a foamed layer is effectively prevented, and a method of producing this sheet stably are provided. There are provided a polyolefin resin foamed sheet comprising a polyolefin foamed layer, and a polyolefin resin non-foamed layer containing 10% by weight or more of a recycled polyolefin subjected to at least two cycles of a process comprising melting and solidifying polyolefin selected from the group consisting of polyolefin having long chain branched and polyolefin having a weight-average molecular weight of 1×10⁵ or more, and a method of producing a polyolefin resin foamed sheet comprising a polyolefin resin foamed layer and a polyolefin resin non-foamed layer wherein a polyolefin layer 1 containing a foaming agent and a polyolefin layer 2 containing 10% by weight or more of a recycled polyolefin subjected to at least two cycles of a process comprising melting and solidifying polyolefin selected from the group consisting of polyolefin having long chain branch and polyolefin having a weight-average molecular weight of 1 ×10⁵ or more are co-extruded, and the polyolefin resin layer 1 is foamed.

### FIELD OF THE INVENTION

The present invention relates to a polyolefin resin foamed sheet excellent in surface smoothness and a method of producing the same.

### BACKGROUND OF THE INVENTION

Polyolefin resin foamed sheets obtained by laminating a polyolefin resin non-foamed layer on at least one surface of a polyolefin resin foamed layer are known, and used as architectural and earthmoving materials, wrapping vessels and the like. However, in a process of producing such a sheet, a phenomenon of collapse of foams in a polyolefin resin foamed layer, what is called foam break, often occurs, and resultantly, an obtained polyolefin resin foamed sheet in some cases is inferior in surface smoothness.

The present inventors have intensively studied for solving this problem, and already found that a polyolefin resin foamed sheet excellent in surface smoothness is obtained by laminating a layer made of polyolefin resin having long chain branch onto a polyolefin resin foamed layer.

However, further investigations have taught that unevenness may occur in the thickness of a non-foamed layer made of polyolefin resin having long chain branch due to its large melting viscosity, resultantly, and appearance on the surface of a foamed layer may not be necessarily satisfied on thinner parts of a non-foamed layer. Particularly, when a relatively thin non-foamed layer is formed, this tendency becomes remarkable, and the surface smoothness of a polyolefin resin foamed sheet may be deteriorated.

An object of the present invention is, in view of the above-mentioned facts, to provide a polyolefin resin foamed sheet excellent in surface smoothness obtained by laminating a non-foamed layer composed of a polyolefin resin on at least one surface of a polyolefin resin foamed layer. A further object of the present invention is to provide a method of producing a polyolefin resin foamed sheet composed of a polyolefin resin foamed layer and a polyolefin resin non-foamed layer in which foam break on the foamed layer is effectively prevented and a sheet excellent in surface smoothness is produced stably.

### SUMMARY OF THE INVENTION

The present inventors have intensively studied for solving the above-mentioned problems, and resultantly found that a polyolefin resin foamed sheet excellent in surface smoothness can be obtained by laminating on a foamed layer made of a polyolefin resin a non-foamed layer made of a polyolefin resin having long chain branch and/or polyolefin resin having weight-average molecular weight of 1×10⁵ or more, which is prepared through two cycles of a process comprising melting solid sate of the polyolefin and solidifying it, and the obtained polyolefin resin foamed sheet is effectively suppressed unevenness in thickness and poor appearance of a foamed layer, leading to completion of the present invention.

Namely, the present invention relates to a polyolefin resin foamed sheet comprising a polyolefin foamed layer, and a polyolefin non-foamed layer containing 10% by weight or more of a recycled polyolefin resin which is subjected at least two cycles of a process comprising melting and solidifying polyolefin selected from the group consisting of polyolefin resins having long chain and polyolefin resins having a weight-average molecular weight of 1×10⁵ or more, and a method of producing a polyolefin resin foamed sheet comprising a polyolefin resin foamed layer and a polyolefin resin non-foamed layer wherein a polyolefin resin layer 1 containing a foaming agent and a polyolefin resin layer 2 containing 10% by weight or more of a recycled polyolefin resin subjected at least two cycles of a process comprising melting and solidifying polyolefin selected from the group consisting of polyolefin having long chain branch and polyolefin having a weight-average molecular weight of 1×10⁵ or more are co-extruded, and the polyolefin resin layer 1 is foamed.

The above-mentioned process including melting and solidifying may be referred to as “melting-solidification process”. The above-mentioned a recycled polyolefin resin subjected at least two cycles of a process including melting and solidifying polyolefin selected from the group consisting of polyolefin having long chain branch and polyolefin having a weight-average molecular weight of 1×10⁵ or more may be referred to as simply “recycled polyolefin resin”.

### BRIEF DESCRIPTION OF DRAWINGS

FIG. 1 is a schematic view of a suitable embodiment of the constitution of an apparatus of producing a polyolefin resin foamed sheet.

FIG. 2 is a sectional view exemplifying a suitable constitution of a head in an apparatus of producing a polyolefin resin foamed sheet.

### DETAILED DESCRIPTION OF THE INVENTION

The polyolefin resin constituting a foamed layer in a polyolefin resin foamed sheet of the present invention may be a polyolefin resin which can form a foamed structure and maintain this structure, and examples thereof include homopolymers of olefins having 2 to 6 carbon atoms such as ethylene, propylene, butene, pentene, hexene, and the like, olefin copolymers constituted of 2 or more monomers selected from olefins having 2 to 10 carbon atoms. The copolymer may be any of a block copolymer, random copolymer and graft copolymer. For formation of a polyolefin resin foamed layer, one polyolefin resin may be used, or 2 or more polyolefin resins may be blended. From the viewpoint of heat resistance, a polypropylene resin is preferable, and it is preferable that a polyethylene resin is compounded in small amount in a polypropylene resin, for improving molding property.

As the particularly preferable polypropylene resin, homopolymers of propylene and propylene copolymers containing a propylene unit in 50 mol % or more, are listed. As preferable examples of the component copolymerized with propylene in a propylene copolymer, ethylene and α-olefins having 4 to 10 carbon atoms are listed. Examples of the α-olefin having 4 to 10 carbon atoms include 1-butene, 4-methylpentene-1, 1-hexene and 1-octene. The content of monomer units other than propylene in the propylene copolymer is preferably 10% by weight or less for ethylene, and preferably 30% by weight or less for an α-olefin.

Of polypropylene resins, (a) polypropylenes having long chain branch and (b) polypropylene resins having a weight-average molecular weight of 1×10⁵ or more are suitable since a foamed layer having a bubble structure of high uniformity can be formed with these resins.

These polypropylene resins are particularly preferable those in which uniaxial melt extension viscosities η₁ and η₁₀₀ at 1 second and 100 second respectively from initiation of strain satisfy η₁₀₀/η₁≧10 when uniaxial melt extension viscosity is measured by an apparatus such as Meissener-type extension rheometer (for example, Meltene Rheometer manufactured by Toyo Seiki K. K.) and the like under a temperature condition of the melting point +30° C. and at an extension strain speed of 0.1 sec⁻¹.

As the foaming agent used in a polyolefin resin foamed sheet of the present invention, both of so-called chemical foaming agents and physical foaming agents can be used, and as the chemical foaming agent, thermal decomposition type foaming agents generating a nitrogen gas (azodicarboneamide, azobisisobutyronitrile, dinitrosopentamethylenetetramine, p-toluenesulfonylhydrazide, p,p′-oxy-bis(benzenesulfonylhydrazide) and the like), thermal decomposition type inorganic foaming agents generating a carbon dioxide gas (sodium bicarbonate, ammonium carbonate, ammonium bicarbonate and the like) and the like are listed, and as the physical foaming agent, propane, butane, water, carbon dioxide gas and the like are listed. Among them, substances inactive to high temperature conditions and fire such as water, carbon dioxide gas and the like are suitable. Particularly when a polypropylene resin is used as a resin constituting a foamed layer, use of a carbon dioxide gas is suitable.

In the present invention, the use amount of a foaming agent may be advantageously controlled depending on the kind of a foaming agent, the kind of a resin, and the like appropriately so as to obtain desired foaming magnification.

Next, the polyolefin resin material constituting a non-foamed layer is illustrated.

The polyolefin resin used in a non-foamed layer of a polyolefin resin foamed sheet of the present invention is characterized in that a polyolefin contains 10% by weight or more are cycled polyolefin resin subjected to at least two cycles of a process comprising melting and solidifying (melting-solidification process) polyolefin selected from the group consisting of polyolefin having long chain branch and polyolefin having a weight-average molecular weight of 1×10⁵ or more.

By including a recycled polyolefin as a material into a non-foamed layer, a non-foamed layer having small unevenness in thickness can be formed easily. As a result, foam break in forming a foamed layer can be prevented, and a foamed sheet excellent in surface appearance can be obtained efficiently.

In the present invention, the polyolefin having long chain branch is a polyolefin resin having a branching index [A] satisfying 0.20≦[A]≦0.98, and polyolefin such as olefin copolymers composed of two or more monomers selected from olefins having 2 to 10 carbon atoms, and homopolymers of olefins having 2 to 6 carbon atoms such as ethylene, propylene, butene, pentene, hexene and the like. The copolymer maybe any of a block copolymer, random copolymer and graft copolymer. From the viewpoint of heat resistance, polypropylene resins are particularly preferable.

As polyolefin having a branching index [A] satisfying 0.20≦[A]≦=0.98, PF-814, polypropylene manufactured by Montel is exemplified.

The branching index indicates the extent of long chain branching, and is a numerical value defined by the following formula.

Branching index [A]=[η]Br/[η]Lin

Here, [η]Br is an intrinsic viscosity of a polyolefin resin having a long chain branch, and [η]Lin is an intrinsic viscosity of a linear polyolefin having the same repeating unit and the same weight-average molecular weight as those of the polyolefin resin having a long chain branch.

The intrinsic viscosity is also called limiting viscosity number, and depends particularly on the molecular weight and degree of branching of a polymer molecule. Therefore, when a polymer having a long chain branch is compared with a linear polymer having the same weigh-average molecular weight, the intrinsic viscosity indicates the measure of degree of branching of a polymer, and the ratio of the above-mentioned intrinsic viscosity is used as the branching index. A method of measuring the intrinsic viscosity of a polypropylene is described by Eriot et al. [J. Appl. Polym. Sci. 14, 2947-2963 (1970)]. The intrinsic viscosity of a polypropylene can be measured at for example 135° C. using a sample dissolved in tetralin or orthodichlorobenzene. The weight-average molecular weight (Mw) can be measured by various methods, and a method published in M. L. McConnel, American Laboratory, May, 63-75 (1978), namely, a low angle laser light scattering strength measuring method is particularly preferably used.

In the present invention, as the polyolefin resin having a weight-average molecular weight of 1×10⁵ or more, polyolefin resins such as olefin copolymers constituted of 2 or more monomers selected from olefins having 2 to 10 carbon atoms, and homopolymers of olefins having 2 to 6 carbon atoms such as ethylene, propylene, butene, pentene, hexene and the like having a weight-average molecular weight of 1×10⁵ or more. The copolymer may be any of a block copolymer, random copolymer and graft copolymer. From the viewpoint of heat resistance, polypropylene resins are particularly preferable.

As a method of producing a polypropylene resin having a weight-average molecular weight of 1×10⁵ or more, the following method is exemplified.

In a first step, propylene is polymerized by feeding a trialkylaluminum such as triethylaluminum and the like, a silane compound such as t-butyl-n-propyldimethoxysilane and the like, and a solid catalyst component previously activated, in given amounts, under given polymerization temperature and polymerization pressure. The resulted polymer is continuously transferred to a second step without deactivating a catalyst. In the second step, propylene and hydrogen are fed while maintaining hydrogen as a molecular weight controlling agent at given concentration under given polymerization temperature and polymerization pressure, and propylene polymerization is continued while feeding the catalyst-containing polymer transferred from a first step and a trialkylaluminum and silane compound, to obtain a polymer having high intrinsic viscosity.

The weight-average molecular weight of a polypropylene resin can be controlled by regulating the feeding amount of a monomer constituting a resin.

As one example of a melting-solidification process of a polyolefin resin, a process is exemplified in which a polyolefin resin in solid condition, for example, in the form of a pellet, is melted in a plastication apparatus (for example, extruder), extruded to give any form such as a strand, sheet, and the like, and solidified by cooling. Usually, a polymer obtained by polymerization is obtained in the form of a powder, and it is general that the powder is once melt-solidified to give pellets used in various fields. Therefore, the phrase “subjected at least two cycles of a melting-solidification process (or process comprising melting and solidifying)” means that a powder is processed into a pellet, and a melt-solidification process such as molding and the like is effected at least once.

It is also possible that a molded body such as a film, sheet and the like produced by an appropriate molding method such as extrusion molding and the like using polyolefin having long chain branch and/or a polyolefin having a weight-average molecular weight of 1×10⁵ or more, or odd materials generated in producing the above-mentioned molded article are recycled, and used as a recycled polyolefin in the method of the present invention.

When such a molded body or odd materials are recycled in the present invention, this molded body or odd materials may contain a polyolefin resin other than polyolefin having a long chain branch and/or a polyolefin having a weight-average molecular weight of 1×10⁵ or more.

The recycled polyolefin may advantageously be that obtained through at least two cycles of a melting-solidification process, and the cycle number of a melting-solidification process is not particularly limited, and usually, it is preferable to use a recycled polyolefin resin obtained through two or three cycles of a melting-solidification process.

The polyolefin resin material forming a polyolefin resin non-foamed layer contains the above-mentioned recycled polyolefin in an amount of 10% by weight or more. When the content of a recycled polyolefin is less than 10% by weight, unevenness in thickness occurs in a non-foamed layer to be formed, and an effect of preventing bubble break in forming a foamed layer may not be obtained in some cases. As a result, it is difficult to obtain a foamed sheet in surface smoothness. In view of deterioration of a resin through a melting-solidification process, the content of a recycled polyolefin is more preferably from 20 to 80% by weight, particularly preferably from 30 to 50% by weight.

The polyolefin used for non-foamed layer may be constituted only of the above-mentioned recycled polyolefin, and when a recycled polyolefin is contained in an amount of 10% by weight or more, a polyolefin resin other than the above-mentioned recycled polyolefin may be contained.

As the polyolefin resin which can be used together with a recycled polyolefin, polyolefin resin selected from polyolefin having long chain branch and polyolefin having a weight-average molecular weight of 1×10⁵ or more which polyolefin resin have not been subjected to a melting-re-solidification process are listed. Further, polyolefin resin other than polyolefin having long chain branch and polyolefin having a weight-average molecular weight of 1 ×10⁵ or more can also be used. Also, polyolefin resins modified with a carboxylic acid and carboxylic anhydride can be applied. Furthermore, copolymers of an olefin with a monomer polymerizable with this olefin, and such copolymers modified with a carboxylic acid and carboxylic anhydride can also be applied.

It is possible that a recycled polyolefin and the above-mentioned polyolefin resin which can be used with a recycled polyolefin are previously melt-kneaded to give a composition before it is used in a non-foamed layer. In this operation, a desired additive can be compounded.

The foamed sheet of the present invention may also be laminated with a layer (hereinafter, sometimes referred to as additional layer) other than a polyolefin resin foamed layer and a polyolefin resin non-foamed layer containing a recycled polyolefin in an amount of 10% by weight or more.

The above-mentioned additional layer may be co-extruded with a polyolefin resin foamed layer and/or a polyolefin resin non-foamed layer, or may be laminated via an adhesive layer and adhesive resin layer.

By lamination of an additional layer, mechanical properties such as bending rigidity, compression strength, surface scratching property, dimension stability and the like, and functions such as heat resistance, heat insulation property, gas barrier property, molding property and the like can be improved, and properties such as gloss, surface smoothness, appearance beauty and the like can be imparted. As the additional layer, there are listed layers made of woven fabric, non-woven fabric, knitted fabric, sheet, film, net and the like.

Materials of the additional layer can be appropriately selected depending on the object, and examples thereof include thermoplastic resins, thermosetting resins, rubber, thermoplastic elastomer, natural fibers such as hemp and the like, minerals such as calcium silicate and the like. Further, wood, paper, synthetic paper made of polypropylene, polystyrene or the like, thin plates and foils of metals such as aluminum, iron and the like can also be used. Such an additional layer may also be endowed with concave and convex patterns such as graining and the like, printing, dyeing and the like. Such an additional layer may have a single layer structure, or a multi-layer structure composed of two or more layers.

Examples of a thermoplastic resin constituting such an additional layer include polyolefin resins, ethylene-vinylester copolymers and saponified substances thereof, polyester resins, polyamide-based resins, halogen-containing resins and the like.

When the polyolefin resin foamed sheet of the present invention is applied to food containers, it is preferable that the above-mentioned layer composed of a thermoplastic resin has an additional layer such as a layer of an unstretched polypropylene film (CPP), stretched polypropylene film (OPP), ethylene-vinyl ester copolymer film (EVOH) and the like.

The polyolefin resin foamed sheet of the present invention preferably has a layer composed of a thermoplastic resin film blended with a dioxin-suppressing agent as an additional layer, to suppress load on environments in burning a sheet.

When the polyolefin resin foamed sheet of the present invention is used for wrapping of substances which deteriorate easily such as vegetables, live flowers and the like, a layer composed of a thermoplastic resin film containing an ethylene gas absorber, freshness keeping agent, deodorizer, anti-fungal agent and the like can be used as an additional layer.

The film to be laminated on a foamed sheet may be a single layer film composed a single film, or a multi-layer film obtained by laminating two or more films. The thickness of the film to be laminated on a foamed sheet is preferably from 10 to 100 μm, and in the case of a multi-layer film, preferably from 50 to 200 μm.

When a polyolefin resin foamed sheet obtained according to the present invention is applied to food containers, specific examples of the film to be laminated on a foamed sheet include a CPP film having a thickness of 50to 100 μm, a three component four-layer multi-layer film having a thickness of 100 μm composed of CPP layer/adhesive layer/EVOH layer/adhesive layer, a three component five-layer multi-layer film having a thickness of 100 μm composed of CPP layer/adhesive layer/EVOH layer/adhesive layer/CPP layer, a three component five-layer multi-layer film having a thickness of 100 μm composed of CPP layer/adhesive layer/nylon layer/EVOH layer/adhesive layer/CPP layer, and the like.

In the polyolefin resin foamed sheet of the present invention, a polyolefin resin non-foamed layer containing 10% by weight or more of a recycled polyolefin may be laminated on at least one surface of a polyolefin resin foamed layer directly, namely, not via other layer, or indirectly, namely, via one or more additional layers.

In this case, as the additional layer provided between the above-mentioned formed layer and non-foamed layer, the additional layer made of a polyolefin resin selected from the above-mentioned polyolefin having long chain branch and polyolefin having a weight-average molecular weight of 1×10⁵ or more, is suitable. By using such a layer as an intermediate layer, a foamed sheet excellent in surface smoothness can be obtained stably, and the surface smoothness of the resulting sheet is also excellent.

The above-mentioned additional layer can be provided by, for example, a method in which a sheet (or film) corresponding to the above-mentioned layer is laminated to the above-mentioned foamed sheet via an adhesive layer, and a method in which the above-mentioned additional layer is heat-laminated on a foamed layer and a non-foamed layer.

The foaming ratio of a foamed layer contained in the polyolefin resin foamed sheet of the present invention is preferably from 2-fold to 40-fold. The foaming ratio of a foamed layer of a foamed sheet can be controlled by regulating the addition amount of a foaming agent used and physical conditions in molding processing.

The thickness of the polyolefin resin foamed sheet of the present invention is preferably from 0.1 to 3 mm. The thickness of a non-foamed layer may be set appropriately depending on use of a sheet, and the like and is not restricted, and suitably 1 μm or more, more preferably 10 μm or more, further preferably 50 μm or more.

Regarding the constitution of the polyolefin resin foamed sheet of the present invention, there are exemplified also a foamed sheet having a structure of non-foamed layer/foamed layer/non-foamed layer obtained by laminating a non-foamed layer on both sides of a foamed layer, and further, a foamed sheet having a structure of non-foamed layer/foamed layer/non-foamed layer/foamed layer/non-foamed layer obtained by laminating two foamed layers via a non-foamed layer and further laminating a non-foamed layer on the outside of both foamed layers.

Furthermore, a foamed sheet having a structure of recycled polyolefin resin-containing non-foamed layer/no recycled polyolefin-based resin-containing no-foamed layer/foamed layer/no recycled polyolefin-based resin-containing no-foamed layer/recycled polyolefin resin-containing non-foamed layer is also exemplified.

Each layer in the polyolefin resin foamed sheet of the present invention can appropriately contain additives. As the addition, an antioxidant, light stabilizer, ultraviolet absorber, anti-fogging agent, mist preventing agent, plasticizer, antistatic agent, lubricant, coloring agent, dioxin-suppressing agent, ethylene gas absorber, deodorizer, freshness keeping agent, anti-fungal agent and the like are listed. These additives can be compounded. These additives may be compounded in a foamed layer, non-foamed layer, and both of them, in the sheet of the present invention. It is preferable that a layer composed of a thermoplastic resin film into which a dioxin-suppressing agent is compounded is contained as an additional layer, for suppressing load on environments particularly in burning a sheet.

When a polyolefin-based resin foamed sheet obtained by the method of the present invention is used for wrapping of substances which deteriorate easily such as vegetables, live flowers and the like, a layer composed of a thermoplastic resin film containing an ethylene gas absorber, freshness keeping agent, deodorizer, anti-fungal agent and the like can be used as an additional layer.

Regarding compounding of these additives, constituent materials of a polyolefin resin foamed sheet obtained by the method of the present invention and additives can be previously kneaded to give a resin composition which is used, or, a master batch of additives or additives themselves can be compounded by dry blend, in the method of the present invention.

Next, the method of producing a polyolefin resin foamed sheet of the present invention is described below.

In the production method of the present invention, a polyolefin resin layer 1 containing a foaming agent and a polyolefin resin layer 2 containing 10% by weight or more of a recycled polyolefin resin subjected at least two cycles of a process comprising melting and solidifying a polyolefin selected from the group consisting of polyolefin having long chain branch and polyolefin having a weight-average molecular weight of 1×10⁵ or more (re-solidified polyolefin resin) are co-extruded, and the polyolefin resin layer 1 is foamed, to obtain a polyolefin resin foamed sheet.

Usually, a polyolefin resin containing a foaming agent, and a polyolefin resin containing 10% by weight or more of a recycled polyolefin resin are plasticized by heating, and these are laminated by passing through a die having a structure which can laminate them, further, they are co-extruded from this die. In the method of the present invention, the polyolefin resin layer 1 obtained by plasticization of a polyolefin resin containing a foaming agent is mainly extruded from a die before foaming, though foaming may initiate in the die.

In the method of the present invention, as the die for co-extrusion, flat dies (for example, T die, coat hanger die and the like), straight dies, circular dies (cross head die and the like), etc. are preferably used, however, the die is not necessarily limited to them.

In the case of a circular die, the caliber is preferably about 50 mmø or more, more preferably about 80 mmø or more.

The polyolefin foamed sheet co-extruded can be streched, if necessary.

As the method of stretching a polyolefin resin foamed sheet, there are listed a method in which a foamed sheet extruded through a circular die is stretched along an internal mandrel, a method in which a sheet extruded through a circular die is swollen by air blow, a method in which a sheet extruded through a T die is stretched along TD direction by a tenter stretching machine, and the like.

In the case of stretching of a foamed sheet extruded from a circular die, the stretching ratio is preferably 2 fold or more and 10 fold or less, and more preferably 2.5 fold or more and 10 fold or less, particularly preferably 3 fold or more and 10 fold or less. When the stretching ratio is less than 2 fold, wrinkle may be formed on the surface of a sheet. On the other hand, when the strething ratio is over 10 fold, a sheet may be broken during stretching. Here, the stretching ratio means a ratio of the internal diameter of a foamed sheet after stretching to the internal diameter of a circular die.

In the case of stretching along TD direction by a tenter stretching machine of a sheet extruded through a T die, the stretching ratio is preferably 2 fold or more and 4 fold or less along TD direction.

For increasing the foaming ratio of a foamed layer, it is preferable that a sheet extruded from a die is allowed to pass through a vacuum chamber. In a vacuum chamber, a foamed layer is further foamed, and by this, a foamed sheet having a foamed layer having high foaming ratio can be obtained.

In the method of the present invention, a polyolefin resin layer 2 can be laminated onto at least one surface of a polyolefin resin layer 1 containing a foaming agent, directly via no other layer, and co-extruded.

Alternatively, a polyolefin resin layer 2 can be laminated onto a polyolefin resin layer 1 containing a foaming agent, indirectly via one or more layers, and co-extruded.

In this case, as the above-mentioned layer provided between a polyolefin resin layer 1 containing a foaming agent and a polyolefin resin layer 2 containing a recycled polyolefin resin, a layer made of a polyolefin resin selected from the above-mentioned polyolefin having long chain branch and polyolefin having a weight-average molecular weight of 1×10⁵ or more which are raw material resin for a recycled polyolefin resin, is suitable. By co-extruding such a layer as an intermediate layer, a foamed sheet excellent in surface smoothness can be produced more stably, and the surface smoothness of the resulting foamed sheet is also excellent.

One example of the method for producing a polyolefin resin foamed sheet of the present invention is described below referring to drawings.

In this example, a carbon dioxide gas is used as a foaming agent, melting is effected in a first extruder, pellets are melt-extruded by a twin screw extruder onto both surfaces of a layer which has been thermally plasticized made of a polyolefin resin prepared by mixing a carbon dioxide gas, then, the extruded material is cooled and solidified to give a long chain branched polypropylene resin. 40 parts by weight of this long chain branched polypropylene resin and 60 parts by weight of a polypropylene which has not passed through a melting-re-solidification process is melt-kneaded in a second extruder to give a resin composition. A thermally plasticized layer made of this resin composition is laminated in a die and co-extruded, and the intermediate layer is foamed to give a polyolefin resin foamed sheet having a three layer structure of non-foamed layer/foamed layer/non-foamed layer.

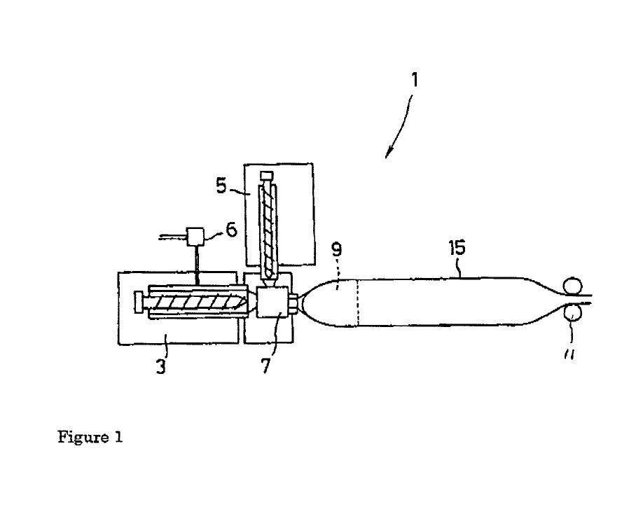

FIG. 1 shows one example of the production apparatus used for producing a polyolefin resin foamed sheet of the present invention. The production apparatus 1 has a first extruder 3 for extruding constituent materials of a foamed layer, a second extruder 5 for extruding constituent materials of a non-foamed surface layer, a die 7, a mandrel 9, and a drawing roll 11.

The first extruder 3 has a hopper for feeding a resin, and a pump 6 for feeding a carbon dioxide gas which is a foaming agent. A polypropylene resin put into a cylinder of the extruder 3 from the hopper is melted while being transported toward the die 7. A carbon dioxide gas is fed into the extruder at a position at which a well-melted polypropylene resin in the extruder passes through, and dispersed uniformly into the melted polypropylene resin. The melted polypropylene containing a foaming agent is transferred into the die 7. An embodiment is suitable in which a known bent type extruder is used as the first extrude, and a carbon dioxide gas is fed under pressure from a bent pore.

The resin composition obtained by melt-kneading in the second extruder 5 of 40 parts by weight of polypropylene having long chain branch which is prepared by melt-extrusion in a twin screw extruder, cooling, and solidifying and 60 parts by weight of a polypropylene which has not passed a melting-re-solidification process is transferred into the die 7 from the above-mentioned extruder 5.

Constituent materials of a foamed layer and constituent materials of a non-foamed layer are laminated in melted condition in the die and extrude, and the residence time in the die after lamination is suitably from about 0.1 to about 20 seconds, and more preferably from about 0.5 to about 15 seconds.

A three-layer foamed sheet fed in the form of tube from the die is molded into a tube 15 having given diameter by the mandrel 9, and folded and drawn by the drawing roller 11 after cooling. This is cut at both folded parts to give two three-layer foamed sheets. When it is cut only at one folded part, one three-layer foamed sheet having large width is obtained.

When two of the resulted three-layer foamed sheets are laminated, a foamed sheet is obtained having six layers of non-foamed layer/foamed layer/non-foamed layer/non-foamed layer/foamed layer/non-foamed layer or five layers of non-foamed layer/foamed layer/non-foamed layer/foamed layer/non-foamed layer. Further, three or more of the above-mentioned three-layer foamed sheets can be laminated.

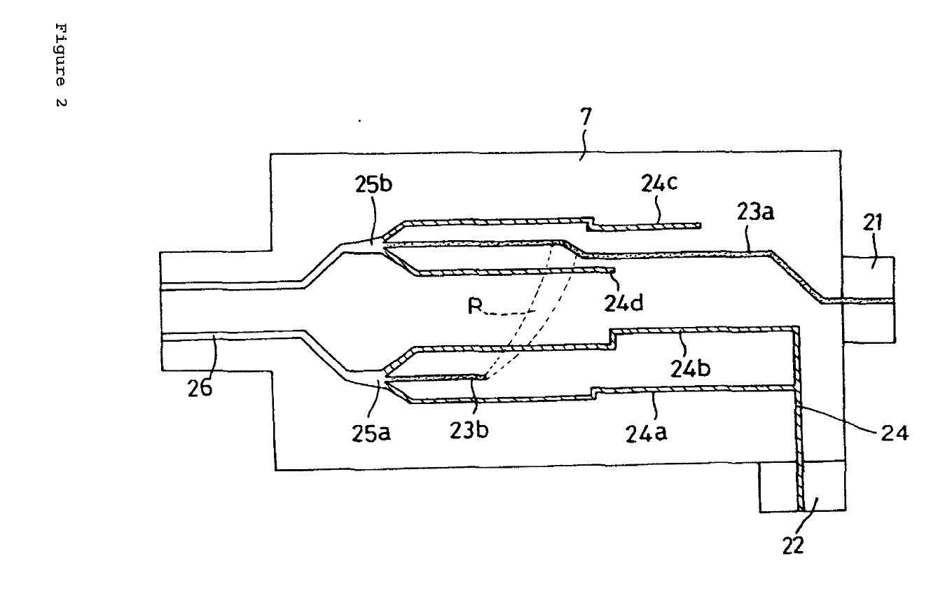

A suitable structure of the die is shown in a sectional view of FIG. 2. The die in this example is a circular die. The die 7 has flow routes 23a and 23b for a resin forming a foamed layer, and flow routes 24, 24a, 24b, 24c and 24d for a resin forming a non-foamed layer.

A head 21 of the first extruder 3 is connected to the end part of original flow side of the resin flow route direction of the die 7, and a head 22 of the second extruder 5 is connected to the side part of original flow side. The melted resin for foaming a foamed layer fed from the head 21 first enters the flow route 23a, and is transported toward the die outlet direction. On its way, the resin is branched through a path P, and fed into the flow route 23b.

On the other hand, the melted resin for forming a non-foamed layer is fed from a head of the second extruder 5, and divided into 24a and 24 b at the flow route 24, and so fed as to adhere both surfaces of the flow route 23b to cover both surfaces of a foamed layer, and makes multi layers at 25a. The melt resin fed to the flow routes 24a and 24b is fed through a dividing flow route (not shown) resembling the path P to 24c and 24d so as to cover both surfaces of a flamed layer of the flow route 23a, and makes multi layers at 25b.

The melted resin forming cylindrical form having a three-layer structure at 25a and 25b is extruded from the die outlet 26. By this release into atmospheric pressure, a carbon dioxide gas in the constituent resin of a foamed layer expands to form bubbles, leading to formation of a foamed layer.

In the above-mentioned method, the discharge amount of the melted resin (Q: kg/hr mm) and the internal diameter of the die 7 (D: mm) preferably satisfy the relation of Q/D≧about 0.3 kg/hr mm, and more preferably satisfy the relation of Q/D ≧about 0.6 kg/hr mm.

The lip clearance of the die outlet 26 is preferably from about 0.5 to about 3 mm, and more preferably from about 1 to about 2 mm. The taper angle at the die outlet is preferably from about 0° to about 5°, and more preferably from about 0° to about 1°. The taper land length is preferably about 10 mm or less, and more preferably about 5 mm or less. The angle formed by the core center part of the die and the taper land at the die outlet is preferably from about 45° to about 80°, and more preferably from about 50° to about 70°.

In the above-mentioned example, a single screw extruder is used in any cases, however, a twin screw extruder and the like may also be used. Particularly, it is preferable to use a twin screw extruder as the extruder for extruding constituent materials of a foamed layer.

In the above-mentioned example, though a circular die is used as the die 7, the dies used in the method of the present invention may advantageously have an internal structure suitable for forming a multi-layer sheet, and flat dies (T die, coat hanger die and the like) and straight dies can be applied, as described above.

The polyolefin resin foamed sheet of the present invention can be processed by molding and the like and used in various fields, if necessary. Specifically, this sheet can be utilized for food containers such as vessels usable in an electric oven (HMR) and the like, heat insulation materials, cushioning materials for sport goods, wrapping materials and the like, automobile parts such as heat insulation materials, car ceiling materials and the like, sealing materials, construction materials, fields using a resin which is required to have heat insulation property in the aerospace and aircraft industry, and the like. Particularly, this sheet can be suitably used as a food container such as vessels usable in a microwave oven, laminated with a layer made of a barrier resin. As examples of the food container, trays, cups, boxes and the like are listed.

According to the present invention, bubble break in foaming of a polyolefin resin foamed layer can be effectively prevented, and a polyolefin resin foamed sheet excellent in surface smoothness can be provided.

The surface smoothness of a polyolefin resin foamed sheet can be evaluated according to the following method.

According to a method for measuring the average roughness at the center line defined in JIS B0601, the surface roughness is measured as a scan speed of 0.3 mm/sec. over a length of 1 cm from any point on a specimen (foamed sheet). This measurement is effected on any three points, and the average value of the resulted surface roughness is referred to as the surface roughness Ra of the foamed sheet. When this Ra value is smaller, a foamed sheet has more excellent surface smoothness.

Though Ra is about 4.8 μm in conventional propylene-based resin foamed sheets, in the present invention, a sheet excellent in surface smoothness having a Ra of 3.8 μm or less is obtained.

### EXAMPLES

The following examples illustrate the present invention, but do not limit the scope of the invention.

The surface smoothness of a foamed sheet resulted in each example was evaluated according to the following method.

A specimen of given form was set on a stylus type roughness meter (trade name: Sufcom 570A; made by Tokyo Seiki K.K.), and the surface roughness was measured at a scan speed of 0.3 mm/sec. over 1 cm from any point on the specimen according to a method for measuring the average roughness at the center line defined in JIS B0601. This measurement was effected on any three points, and the average value of the resulted surface roughness was used as the surface roughness of the foamed sheet. When this Ra value is smaller, the surface smoothness of the foamed sheet is more excellent.

### Example 1

A polyolefin resin foamed sheet having a two-kind and three-layer structure of non-foamed layer/foamed layer/non-foamed layer was produced according to the following procedure.

(Constituent material of foamed layer)

A mixture prepared by blending at a weight ratio of 70/30 of a polypropylene and a polyethylene obtained by a two-stage polymerization method was used as a constituent material of a foamed layer. A method of producing this propylene, a method of palletizing it, and a method of blending a constituent material of a foamed layer are described below.

(1) Synthesis of solid catalyst

A 200 L stainless reaction vessel equipped with a stirrer was purged with nitrogen, then, into this was charged 80 L of hexane, 6.55 mol of tetrabutoxytitanium, 2.8 mol of diisobutyl phthalate and 98.9 mol of tetraethoxysilane, to give a uniform solution. Then, 51 L of a solution of butyl magnesium chloride in diisobutyl ether having a concentration of 2.1 mol/L was added dropwise gradually over 5 hours while maintaining the temperature in the reaction vessel at 5° C. After completion of addition, the mixture was further stirred for 1 hour, then, separated into solid and liquid at room temperature, and washing of the solid phase with 70 L of toluene was repeated three times. Subsequently, toluene was added to this solution so that the slurry concentration was 0.6 Kg/L, then, a mixed solution of 8.9 mol of n-butyl ether and 274 mol of titanium tetrachloride was added to this, then, 20.8 mol of phthalic chloride was further added, and they were reacted for 3 hours at 110° C. After completion of the reaction, the reaction solution was washed with toluene twice at 95° C. Then, the concentration of the slurry was controlled to 0.6 Kg/L, then, 3.13 mol of diisobutyl phthalate, 8.9 mol of n-dibutyl ether and 137 mol of titanium tetrachloride were added, and they were reacted for 1 hour at 105° C. After completion of the reaction, the reaction solution was separated into solid and liquid at the same temperature, then, the solid phase was washed with 90 L of toluene twice at 95° C. Then, the slurry concentration was controlled to 0.6 Kg/L, then, 8.9 mol of n-dibutyl ether and 137 mol of titanium tetrachloride were added, and they were reacted at 95° C. for 1 hour. After the reaction, the reaction solution was separated into solid and liquid at the same temperature, and the solid phase was washed with 90 L of toluene three times at the same temperature. Subsequently, the slurry concentration was controlled to 0.6 Kg/L, then, 8.9 mol of n-butyl ether and 137 mol of titanium tetrachloride were added, and they were reacted at 95° C. for 1 hour. After completion of the reaction, the reaction solution was separated into solid and liquid at the same temperature, and the solid phase was washed with 90 L of toluene for three times at the same temperature, then, further washed with 90 L of hexane three times, then, dried under reduced pressure, to give 11.0 kg of a solid catalyst component.

The solid catalyst component contained 1.9% by weight of a titanium atom, 20% by weight of a magnesium atom, 8.6% by weight of a phthalate, 0.05% by weight of an ethoxy group, and 0.21% by weight of a butoxy group, and had excellent particulate property and condition containing no fine powder.

(2) Previous activation of solid catalyst component

Into a stainless autoclave having a content volume of 3L equipped with a stirrer was added 1.5 L of n-hexane which had been sufficiently dehydrated and deaerated, 37.5 mmol of triethylaluminum, 3.75 mmol of tert-butyl-n-propyldimethoxysilane and 15 g of the above-mentioned solid catalyst component, and 15 g of propylene was fed continuously over 30 minutes while keeping the temperature in the vessel at from 5 to 15° C., for previous activation of the solid catalyst component.

(3) Polymerization of propylene

First step

In a stainless reaction vessel having a content volume of 300 L, 1.3 mmol/h of triethylaluminum, 0.13 mmol/h of t-butyl-n-propyldimethoxysilane and 0.51 g/h of the solid catalyst component previously activated were fed continuously while feeding liquid propylene at 57 kg/h so as to keep a polymerization temperature of 60° C. and a polymerization pressure of 27 kg/cm²G, to effect polymerization of propylene in the substantial absence of hydrogen, giving a polymer at 2.0 kg/h. The polymer production amount in this procedure was 3920 g per 1 g of the catalyst, and part of the produced polymer was sampled and analyzed, to find an intrinsic viscosity of 7.7 dl/g. The resulted polymer was transferred continuously to a second vessel without deactivation of the catalyst.

Second stage

In a fluidized bed reaction vessel having a content volume of 1 m³ equipped with a stirrer, propylene polymerization was continued by feeding the catalyst-containing polymer transferred from the first vessel, 60 mmol/h of triethylaluminum, and 6 mmol/h of t-butyl-n-propyldimethoxysilane while feeding propylene and hydrogen so as to maintain a polymerization temperature of 80° C., a polymerization pressure of 18 kg/cm²G and a hydrogen concentration in gas phase of 8 vol %, to give a polymer at 18.2 kg/h. This polymer had an intrinsic viscosity of 1.9 dl/g.

From the above-described results, it was found that the polymer production amount in the second stage polymerization was 31760 g per 1 g of the catalyst, the polymerization weight ratio of the first polymerization vessel to the second polymerization vessel was 11/89, and the polymer formed in the second stage polymerization reaction had an intrinsic viscosity of 1.2 dL/g.

(4) Pelletization of polypropylene

0.1 part by weight of calcium stearate, 0.05 parts by weight of a partially hindered phenol-based antioxidant (trade name: Irganox 1010, manufactured by Chiba Specialty Chemicals) and 0.2 parts by weight of a phenol-based antioxidant (trade name: Smilizer BHT, manufactured by Sumitomo Chemical Co., Ltd.) were added to 100 parts by weight of the polypropylene powder obtained in the above-mentioned second stage reaction, and they were melt-kneaded at 230° C. by kneading in an extruder, to obtain a pellet having a melt flow rate (MFR) of 12 g/10 min.

(5) Blend of constituent material of foamed layer

The pellet of propylene obtained through the above-mentioned processes (1) to (4) and a pellet of polyethylene (trade name: Sumikacene G201, manufactured by Sumitomo Chemical Co., Ltd.) were dry-blended at a weight ratio of 70/30.

(Constituent material of non-foamed layer)

A pellet of polypropylene having long chain branch (trade name: Polypropylene PF814, manufactured by Montel; melting point: 159.0° C.; crystallization temperature: 130.1° C.; MFR: 2.2 g/10 min.) was melt-kneaded by a same direction twin screw extruder (trade name: PCM45; manufactured by Ikegai K.K.; screw diameter: 45 mm; screw L/D: 30) at a screw revolution of 200 rpm, extruded to give a strand at a die temperature of 240° C., cooled in water, and solidified, then, cut by a cutter to obtain a resin pellet. 21 parts by weight of this resin pellet, 49 parts by weight of a pellet of polypropylene having long chain branch (Polypropylene PF 814 manufactured by Montel) which had not passed twice or more through a melting-solidification process, and 30 parts by weight of a pellet of a polyethylene (trade name: Sumikacene G201, manufactured by Sumitomo Chemical Co., Ltd.) were dry-blended to obtain a mixture which was used as a constituent material of a non-foamed layer.

(Extrusion foaming)

An apparatus prepared by attaching a 90 mmø circular dice to a 50 mmø twin screw extruder and a 32 mmø single screw extruder was used. A mixture prepared by blending 1 part by weight of a core material (trade name: Hydrocerol; manufactured by Baylinger Ingelhyme Chemicals) with 100 parts by weight of a 70/30 (ratio by weigh) mixture of polypropylene/polyethylene for a foamed layer was put into the 50 mmø twin screw extruder, 1 part by weight of carbon dioxide gas was further injected into this while melt-kneading, to sufficiently knead the resin mixture and a carbon dioxide gas, then, the mixture was fed into a die controlled at 210° C. On the other hand, the above-mentioned dry blended mixture for a non-foamed layer was put into the 32 mmø single screw extruder, and melt-kneaded and fed into a die controlled at 210° C. The resin composition for a foamed layer from the 50 mmø twin screw extruder and the resin composition for a non-foamed layer from the 32 mm ø single screw extruder were laminated in a die, then, extruded to give a cylinder, and the extruded cylindrical sheet was expanded, while being cooled, along a mandrel having an outer diameter of 210 mm which was set directly after a die and cooled by circulating water of 6° C. through inside. Thus obtained cylindrical two-kind three-layer foamed sheet was cut by a cutter, and opened to give a flat form two-kind three-layer foamed sheet, and stretched by a stretching machine. The physical properties of the resulted foamed sheet were evaluated. The results are shown in Table 1.

### Example 2

A foamed sheet was produced by the same manner as in Example 1 except that the following resin mixture was used as a constituent material of a non-foamed layer, and the physical properties thereof were evaluated. The results are shown in Table 1. The non-foamed layer of the resulted foamed sheet contained a recycled polyolefin resin in an amount of 48% by weight.

(Constituent material of non-foamed layer)

A foamed layer having the same composition as that of the foamed layer in the foamed sheet produced in Example 1 and a non-foamed layer made of polypropylene having long chain branch (Polypropylene PF814 manufactured by Montel) were used. On both sides of a constituent resin of a foamed layer which had been thermally plasticized, a constituent resin of a non-foamed sheet which had been thermally plasticized was laminated, and co-extruded from a die controlled at 210° C. while foaming the above-mentioned constituent resin of a foamed layer, to give a sheet. This sheet was drawn while being solidified by cooling, along an internal mandrel which had been cooled by circulation of water of 6° C. through inside, to obtain a two-kind three-layer foamed sheet having a layer structure of non-foamed layer/foamed layer/non-foamed layer=80/2200/80 μm. Onto this sheet was laminated a multi-layer film having a thickness of 100 μm produced by laminating constituent resins thermally plasticized so as to give a layer constitution of non-stretched polypropylene layer/maleic anhydride-modified polypropylene layer/ethylene-vinyl ester copolymer saponified substance layer/maleic anhydride-modified polypropylene layer/non-drawn polypropylene layer=25/10/30/10/25 μm, co-extruding the laminate from a die of 210° C., and cooling and solidifying the extruded substance by stretching the extruded substance along a cooling roll which had been cooled by circulation of water of 10° C. through inside. Thus obtained multi-layer sheet was scrapped to obtain a resin material. To 35 parts by weight of the resulted resin material was compounded 35 parts by weight of polypropylene having long chain branch (Polypropylene PF814 manufactured by Montel) which had not passed twice or more a melting-solidification process and 30 parts by weight of a polyethylene (trade name: Sumikacene G201, manufactured by Sumitomo Chemical Co., Ltd.), to give a resin mixture which was used.

### Example 3

A resin (A) and a resin (B) described below were used as constituent materials of a non-foamed layer, and a three-kind five-layer polyolefin-based resin foamed sheet having a constitution of non-foamed layer of resin (A)/non-foamed layer of resin (B)/foamed layer/non-foamed layer of resin (B)/non-foamed layer of resin (A) was produced by a co-extrusion foaming method according to the following procedure, and the physical properties thereof were evaluated. The results are shown in Table 1.

(Constituent material of non-foamed layer)

Resin (A)

Polypropylene having long chain branch (trade name: Polypropylene PF814, manufactured by Montel) was melt-kneaded by a same direction twin screw extruder (trade name: PCM45; manufactured by Ikegai K.K.) at a screw revolution of 200 rpm, extruded to give a strand at a die temperature of 240° C., cooled in water, and solidified, then, cut by a cutter to obtain a resin pellet. 21 parts by weight of this resin pellet, 49 parts by weight of a pellet of polypropylene long chain branch (Polypropylene PF 814 manufactured by Montel) which had not passed twice or more through a melting-solidification process, and 30 parts by weight of a pellet of a polyethylene (trade name: Sumikacene G201, manufactured by Sumitomo Chemical Co., Ltd.) were dry-blended to obtain a mixture which was used as a constituent material (A) of a non-foamed layer.

(Resin (B))

Polypropylene long chain branch (trade name: Polypropylene PF814; manufactured by Montel) was used as a constituent material (B) of a non-foamed layer.

(Extrusion foaming)

An apparatus equipped with a 50 mmø twin screw extruder for extruding a foamed layer, two 32 mmø single screw extruders for extruding a non-foamed layer, and a 90 mmø circular die was used. A mixture prepared by blending 1 part by weight of a core material (trade name: Hydrocerol; manufactured by Baylinger Ingelhyme Chemicals) with 100 parts by weight of a 70/30 (ratio by weigh) mixture of polypropylene/polyethylene for a foamed layer was put into the 50 mmø twin screw extruder, 1 part weight of a carbon dioxide gas was further injected into this while melt-kneading, and the resin mixture and a carbon dioxide gas were sufficiently kneaded, then, fed into a die. On the other hand, the resin (A) for a non-foamed layer was put into one 32 mmø single screw extruder and the resin (B) was put into another 32 mmø single screw extruder, respectively, and melt-kneaded and fed into dies, respectively. The resin composition for a foamed layer from the 50 mmø twin screw extruder, and the resin (A) and resin (B) for anon-foamed layer were-laminated in melted condition in a die, then, extruded to give a cylinder, and expanded while being cooled along a mandrel having an outer diameter of 210 mm placed directly after the die. Thus obtained cylindrical three-kind five-layer foamed sheet was cut by a cutter and opened to give a flat form foamed sheet which was stretched by a stretching machine.

### Example 4

(Blend of constituent material of foamed layer)

A pellet of a polypropylene obtained through the above-mentioned steps (1) to (4) and a pellet of a polyethylene (trade name; Sumikacene G201, manufactured by Sumitomo Chemical Co., Ltd.) were dry-blended at a weight ratio of 70/30.

(Constituent material of non-foamed layer)

A pellet of polypropylene having long chain branch (trade name: Polypropylene PF814, manufactured by Montel; melting point: 159.0° C.; crystallization temperature: 130.1° C.; MFR: 2.2 g/10 min.) was melt-kneaded by a same direction twin screw extruder (trade name: PCM45; manufactured by Ikegai K.K.; screw diameter: 45 mm; screw L/D: 30) at a screw revolution of 200 rpm, extruded to give a strand at a die temperature of 240° C., cooled in water, and solidified, then, cut by a cutter to obtain a resin pellet. 30 parts by weight of this resin pellet, and 70 parts by weight of a pellet of polypropylene having long chain branch (Polypropylene PF 814 manufactured by Montel) which had not passed twice or more through a melting-solidification process were dry-blended to obtain a mixture which was used as a constituent material of a non-foamed layer.

(Extrusion foaming)

An apparatus prepared by attaching a 90 mmø circular die to a 50 mmø twin screw extruder and a 32 mmø single screw extruder was used. A mixture prepared by blending 1 part by weight of a core material (trade name: Hydrocerol manufactured by Baylinger Ingelhyme Chemicals) with 100 parts by weight of a 70/30 (ratio by weigh) mixture of polypropylene/polyethylene for a foamed layer was put into the 50 mmø twin screw extruder, 1 part by weight of carbon dioxide gas was further injected into this while melt -kneading, to sufficiently knead the resin mixture and a carbon dioxide gas, then, the mixture was fed into a die controlled at 210° C. On the other hand, the above-mentioned dry blended mixture for a non-foamed layer was put into the 32 mmø single screw extruder, and melt-kneaded and fed into a die controlled at 210° C. The resin composition for a foamed layer from the 50 mmø twin screw extruder and the resin composition for a non-foamed layer from the 32 mm ø single screw extruder were laminated in a die, then, extruded to give a cylinder, and the extruded cylindrical sheet was expanded, while being cooled, along a mandrel having an outer diameter of 210 mm which was set directly after a die and cooled by circulating water of 6° C. through inside. Thus obtained cylindrical two-kind three-layer foamed sheet was cut by a cutter, and opened to give a flat form two-kind three-layer foamed sheet, and stretched by a stretching machine. The physical properties of the resulted foamed sheet were evaluated. The results are shown in Table 2.

### Example 5

A foamed sheet was produced by the same manner as in Example 4 except that the following resin mixture was used as a constituent material of a non-foamed layer, and the physical properties thereof were evaluated. The results are shown in Table 2. The non-foamed layer of the resulted foamed sheet contained a recycled polyolefin resin in an amount of 48% by weight.

(Constituent material of non-foamed layer)

A foamed layer having the same composition as that of the foamed layer in the foamed sheet produced in Example 4 and a non-foamed layer made of polypropylene having long chain branch (Polypropylene PF814 manufactured by Montel) were used. On both sides of a constituent resin of a foamed layer which had been thermally plasticized, a constituent resin of a non-foamed sheet which had been thermally plasticized was laminated, and co-extruded from a die controlled at 210° C. while foaming the above-mentioned constituent resin of a foamed layer, to give a sheet. This sheet was stretched while being solidified by cooling, along an internal mandrel which had been cooled by circulation of water of 6° C. through inside, to obtain a two-kind three-layer foamed sheet having a layer structure of non-foamed layer/foamed layer/non-foamed layer=80/2200/80 μm. Onto this sheet was laminated a multi-layer film having a thickness of 100 μm produced by laminating constituent resins thermally plasticized so as to give a layer constitution of unstretched polypropylene layer/maleic anhydride-modified polypropylene layer/ethylene-vinyl ester copolymer saponified substance layer/maleic anhydride-modified polypropylene layer/unstretched polypropylene layer=25/10/30/10/25 μm, co-extruding the laminate from a dice of 210° C., and cooling and solidifying the extruded substance by drawing the extruded substance along a cooling roll which had been cooled by circulation of water of 10° C. through inside. Thus obtained multi-layer sheet was scrapped to obtain a resin material. To 50 parts by weight of the resulted resin material was compounded 50 parts by weight of polypropylene long chain branch (Polypropylene PF814 manufactured by Montel) which had not passed twice or more a melting-solidification process, to give a resin mixture which was used.

### Example 6

A resin (A) and a resin (B) described below were used as constituent materials of a non-foamed layer, and a three-kind five-layer polyolefin-based resin foamed sheet having a constitution of non-foamed layer of resin (A)/non-foamed layer of resin (B)/foamed layer/non-foamed layer of resin (B)/non-foamed layer of resin (A) was produced by a co-extrusion foaming method according to the following procedure, and the physical properties thereof were evaluated. The results are shown in Table 2.

(Constituent material of non-foamed layer)

Resin (A)

Polypropylene long chain branch (trade name: Polypropylene PF814, manufactured by Montel) was melt-kneaded by a same direction twin screw extruder (trade name: PCM45; manufactured by Ikegai K.K.) at a screw revolution of 200 rpm, extruded to give a strand at a die temperature of 240° C., cooled in water, and solidified, then, cut by a cutter to obtain a resin pellet. 30 parts by weight of this resin pellet and 70 parts by weight of a pellet of polypropylene having long chain branch (Polypropylene PF 814 manufactured by Montel) which had not passed twice or more through a melting-solidification process were dry-blended to obtain a mixture which was used as a constituent material (A) of a non-foamed layer.

(Resin (B))

Polypropylene long chain branch (trade name: Polypropylene PF814; manufactured by Montel) was used as a constituent material (B) of a non-foamed layer.

(Extrusion foaming)

An apparatus equipped with a 50 mmø twin screw extruder for extruding a foamed layer, two 32 mmø single screw extruders for extruding a non-foamed layer, and a 90 mmø circular die was used. A mixture prepared by blending 1 part by weight of a core material (trade name: Hydrocerol; manufactured by Baylinger Ingelhyme Chemicals) with 100 parts by weight of a 70/30 (ratio by weigh) mixture of polypropylene/polyethylene for a foamed layer was put into the 50 mmø twin screw extruder, 1 part weight of a carbon dioxide gas was further injected into this while melt-kneading, and the resin mixture and a carbon dioxide gas were sufficiently kneaded, then, fed into a die. On the other hand, the resin (A) for a non-foamed layer was put into one 32 mmø single screw extruder and the resin (B) was put into another 32 mmø single screw extruder, respectively, and melt-kneaded and fed into dies, respectively. The resin composition for a foamed layer from the 50 mmø twin screw extruder, and the resin (A) and resin (B) for anon-foamed layer were laminated in melted condition in a die, then, extruded to give a cylinder, and expanded while being cooled along a mandrel having an outer diameter of 210 mm placed directly after the die. Thus obtained cylindrical three-kind five-layer foamed sheet was cut by a cutter and opened to give a flat form foamed sheet which was stretched by a stretching machine.

### Comparative Example 1

A foamed sheet was produced by the same manner as in Example 1 except that the following resin was used as a constituent material of a non-foamed layer, and the physical properties thereof were evaluated. The results are shown in Table 1.

(Constituent material of non-foamed layer)

70 parts by weight of a pellet of polypropylene having long chain branch (melting point: 159.0° C.; crystallization temperature: 130.1° C.; MI (230° C.): 2.2 g/10 min.) and 30 parts by weight of a polyethylene (trade name: Sumikacene G201, manufactured by Sumitomo Chemical Co., Ltd.) were dry-blended to give a mixture which was used.

### Comparative Example 2

A foamed sheet was produced by the same manner as in Example 4 except that the following resin was used as a constituent material of a non-foamed layer, and the physical properties thereof were evaluated. The results are shown in Table 2.

(Constituent material of non-foamed layer)

Polypropylene having long chain branch (melting point: 159.0° C.; crystallization temperature: 130.1° C.; MFR (230° C.): 2.2 g/10 min.)

TABLE 1

| | | | | Compara- |
|---|---|---|---|---|
| | Example | Example | Example | tive |
| Item | 1 | 2 | 3 | example 1 |
| Amount of recycled | 21 | 34 | 21 | 0 |
| polyolefin resin | | | | |
| contained in non-foamed | | | | |
| layer (% by weight) | | | | |
| Thickness of sheet (mm) | 1.2 | 1.2 | 1.2 | 1.2 |
| Thickness of non-foamed | 0.1 | 0.1 | 0.1 | 0.1 |
| surface layer (mm) | | | | |
| Thickness of non-foamed | 0 | 0 | 0.1 | 0 |
| layer (mm) | | | | |
| (layer other than foamed | | | | |
| layer and non-foamed | | | | |
| surface layer) | | | | |
| Foaming ratio of foamed | 4.5 | 4.5 | 4.5 | 4.5 |
| layer (fold) | | | | |
| Ra (μm) | 3.7 | 3.8 | 3.2 | 4.8 |

TABLE 2

| | | | | Compara- |
|---|---|---|---|---|
| | Example | Example | Example | tive |
| Item | 4 | 5 | 6 | example 1 |
| Amount of recycled | 30 | 48 | 30 | 0 |
| polyolefin resin | | | | |
| contained in non-foamed | | | | |
| layer (% by weight) | | | | |
| Thickness of sheet (mm) | 1.2 | 1.2 | 1.2 | 1.2 |
| Thickness of non-foamed | 0.1 | 0.1 | 0.1 | 0.1 |
| surface layer (mm) | | | | |
| Thickness of non-foamed | 0 | 0 | 0.1 | 0 |
| layer (mm) | | | | |
| (layer other than foamed | | | | |
| layer and non-foamed | | | | |
| surface layer) | | | | |
| Foaming ratio of foamed | 4.5 | 4.5 | 4.5 | 4.5 |
| layer (fold) | | | | |
| Ra (μm) | 3.7 | 3.8 | 3.2 | 4.8 |

What is claimed is:

1. A polyolefin resin foamed sheet comprising a polyolefin foamed layer, and a polyolefin non-foamed layer containing 10% by weight or more of a recycled polyolefin subjected to at least two cycles of a process comprising melting and solidifying polyolefin selected from the group consisting of polyolefin having long chain branch and polyolefin having a weight-average molecular weight of 1×10⁵ or more.

2. The polyolefin resin foamed sheet according to claim 1 wherein polyolefin having long chain branch is polypropylene having long chain branch and the polyolefin having a weight-average molecular weight of 1×10⁵ or more is a polypropylene having a weight-average molecular weight of 1 ×10⁵ or more.

3. The polyolefin resin foamed sheet according to claim 1 wherein a layer comprising a polyolefin selected from the group consisting of polyolefin having long chain branch and polyolefin having a weight-average molecular weight of 1×10⁵ or more is provided between the foamed layer and the non-foamed layer.

4. A method of producing a polyolefin resin foamed sheet comprising a polyolefin foamed layer and a polyolefin non-foamed layer, wherein a polyolefin layer 1 containing a foaming agent and a polyolefin layer 2 containing 10% by weight or more of a recycled polyolefin subjected to at least two cycles of a process comprising melting and solidifying polyolefin selected from the group consisting of polyolefin having long chain branch and polyolefin having a weight-average molecular weight of 1 ×10⁵ or more are co-extruded, and the polyolefin resin layer 1 is foamed.

5. The production method according to claim 4 wherein the polyolefin having long chain branch is polypropylene having long chain branch and the polyolefin resin having a weight-average molecular weight of 1×10⁵ or more is polypropylene having a weight-average molecular weight of 1 ×10⁵ or more.

6. The production method according to claim 4 wherein a layer 3 made of a polyolefin selected from the group consisting of polyolefin having long chain branch and polyolefin having a weight-average molecular weight of 1×10⁵ or more is further laminated between the polyolefin resin layer 1 and the polyolefin resin layer 2.
